(19) United States
(12) Patent Application Publication
(10) Pub. No.: US 2005/0190656 A1
(43) Pub. Date: Sep. 1, 2005

(54) Data recording apparatus and data recording method

(75) Inventor: Kiyoshige Noguchi, Tokyo (JP)

Correspondence Address: MCGINN & GIBB, PLLC, 8321 OLD COURTHOUSE ROAD, SUITE 200, VIENNA, VA, 22182-3817, US

(73) Assignee: Fuji Jukogyo Kabushiki Kaisha, Tokyo (JP)

(21) Appl. No.: 11/065,588

(22) Filed: Feb. 25, 2005

(30) Foreign Application Priority Data
Feb. 27, 2004 (JP) P2004-055047

(51) Int. Cl. H04H 9/00

(52) U.S. Cl. 369/7

(57) ABSTRACT

Control parameters that are chronologically acquired from a control unit are temporarily recorded into a random access memory. Then, a data control section records a series of control parameters within a predetermined period that have a predetermined acquisition condition into a data recording section, among the chronological control parameters recorded in the random access memory. In this case, at time of shutdown, the data control section records the chronological control parameters recorded in the random access memory into the data recording section irrespective of the acquisition conditions.

The present application claims foreign priority based on Japanese Patent Application No. P.2004-055047, filed Feb. 27, 2004, the contents of which are incorporated herein by reference.

### BACKGROUND OF THE INVENTION

The present invention relates to a data recording apparatus and a data recording method, and more particularly to a technique for recording control parameters in a control unit mounted in a vehicle.

Conventionally, a data recording apparatus, that downloads and records control parameters of a control apparatus mounted in a vehicle to identify a vehicle's failure state, has been known. For example, JP-A-2002-070637 discloses a data recording apparatus that reliably and efficiently records data of a control apparatus. With this data recording apparatus, various data (that is, control parameters) in a vehicle-side control apparatus are chronologically sampled, and the acquired sampling data are stored in an SRAM at any necessary time. Then, if a predetermined trigger condition, which corresponds to a condition by which effective data to identify a vehicle's failure state will be obtained, is satisfied, a series of sampling data stored in the SRAM are downloaded and stored in a data recording section.

Now, the most important function in this type of data recording apparatus is to reliably record data into the data recording section. Normally, data stored in an SRAM are erased by performing a shutdown. Therefore, unless these data are recorded in a data recording section, acquired data are erased with the shutdown. For this reason, in the case where a shutdown occurs unexpectedly by a cut-off of power supply or the like, such a situation arises that data fails to be recorded.

### SUMMARY OF THE INVENTION

The present invention has been accomplished in view of such circumstances, and its object is to reliably record acquired data.

In order to resolve the foregoing problems, a first aspect of the present invention provides a data recording apparatus operating by electric power supplied from a vehicle side and for recording control parameters in a control unit mounted on a vehicle, into a non-volatile memory built in a data recording section that is accessible by an external system. The data recording apparatus has: a random access memory in which control parameters chronologically acquired from the control unit are temporarily recorded; and a data control section recording, into the random access memory, a series of the control parameters within a predetermined period that have an acquisition condition indicating a condition by which vehicle data effective for identifying a failure state of the vehicle will be obtained, among the chronological control parameters recorded in the random access memory. Further, in the data recording apparatus, at time of shutdown, the data control section records, into the data recording section, the chronological control parameters recorded in the random access memory irrespective of the acquisition condition.

Here, in the first aspect, it is preferable that the data control section records the chronological control parameters into the data recording section at time of shutdown, which is performed when electric power supplied from the vehicle side to the data recording section is cut off. In this case, it is preferable that the data recording apparatus further comprises a sub-battery supplying electric power to the data recording apparatus at the time of the shutdown. In the first aspect, it is also preferable that the data control section configures the control parameters recorded in the data recording section as an individual data file each time of shutdown.

A second aspect of the present invention provides a data recording method for a data recording apparatus that operates by electric power supplied from a vehicle side and for recording control parameters of a control unit mounted in a vehicle into a non-volatile memory that is built in a data recording section that is accessible by an external system. The method comprises: a first step of temporarily recording the control parameters chronologically acquired from the control unit into a random access memory; and a second step of recording, into the data recording section, a series of the control parameters during a predetermined period that have an acquisition condition indicating a condition by which data of the vehicle effective for identifying a failure state of the vehicle will be obtained, among the chronological control parameters recorded in the random access memory; and in the second step, at time of shutdown, the chronological control parameters recorded in the random access memory are recorded in the data recording section irrespective of the acquisition condition.

Here, in the second aspect, it is preferable the second step is a step of recording the chronological control parameters into the data recording section at time of shutdown that is performed when electric power supplied from the vehicle side to the data recording section is cut off. In the second aspect, it is also preferable that the second step comprises configuring the control parameters recorded in the data recording section as an individual data file each time of shutdown.

According to the present invention, control parameters recorded in the random access memory are recorded in the data recording section at time of shutdown of the data recording apparatus. Therefore, these data are recorded in the data recording section even when a shutdown is performed by the data recording apparatus. Consequently, even if the data recorded in the random access memory are erased, data preservation can be reliably performed. This makes it possible to reduce the occurrence of such a situation that data recording fails, and therefore, an improvement in reliability of the recorded data can be achieved.

### BRIEF DESCRIPTION OF THE DRAWINGS

FIG. 1 is an explanatory view of a vehicle in which a data recording apparatus according to the present embodiment is applied.

FIG. 2 is a block diagram showing a system configuration of the recording apparatus.

FIG. 3 is an explanatory view showing an example of mode file.

FIG. 4 is a flowchart showing a data recording procedure according to the present embodiment.

FIG. 5 is an explanatory view showing a data group indicating progression of chronological vehicle data recorded in a data recording section.

FIG. 6 is a flowchart showing a detailed procedure of a shutdown process.

### DESCRIPTION OF THE PREFERRED EMBODIMENTS

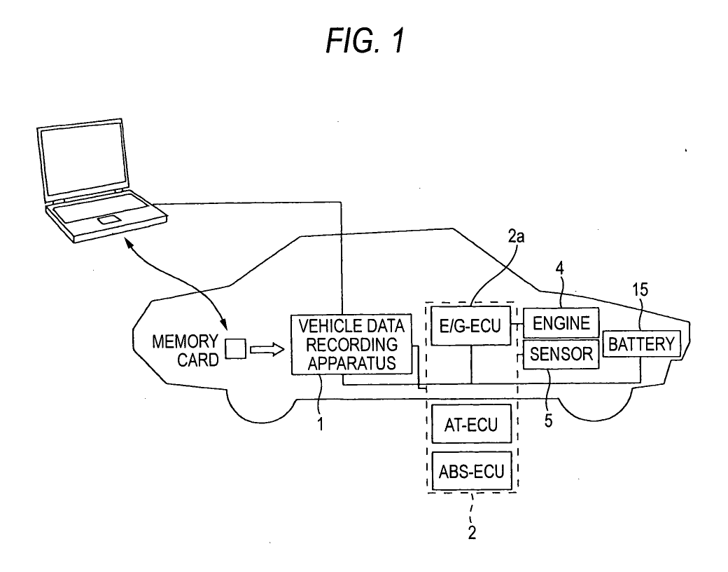

FIG. 1 is an explanatory view of a vehicle to which a data recording apparatus according to the present embodiment is applied. First, prior to explaining a data recording apparatus 1 (hereinafter, simply referred to as “recording apparatus”), a vehicle to which the recording apparatus 1 is applied will be described. In the vehicle, an electronic control unit 2 (hereinafter referred to as “ECU”) is mounted for controlling various apparatus provided in the vehicle. The ECU 2 includes, mainly, a microcomputer, and in the present embodiment, as its representative unit, an engine control unit 2a (hereinafter referred to as “E/G-ECU”) that control an engine 4 will be mainly described. The present invention is, however, likewise applicable to a transmission control unit (AT-ECU) that controls automatic transmission, an ABS control unit (ABS-ECU) that controls an anti-lock brake system, and the like. The present specification uses the term “ECU” as a generic term for these control units.

Sensor detection signal is input from various sensors 5 to the ECU 2 in order to detect the status of the subject of controlling. Examples of these types of sensors 5 include an intake air amount sensor, an intake air pressure sensor, a vehicle speed sensor, an engine speed sensor, a coolant temperature sensor, and acceleration sensor (G sensor). According to a predetermined control program, the ECU 2 performs computation regarding various controlled variables based on the sensor detection signals. Then, the controlled variables calculated by this computation are output to various actuators. For example, the E/G-ECU 2a performs computations regarding fuel injecting width (fuel injection amount), ignition timing, throttle opening degree, and the like, and outputs control signals according to the calculated controlled variables to various actuators. The ECUs 2 mounted in the vehicle are connected to each other by a K-Line (a standard of serial communication) or CAN (Controller Area Network), and can share their information between them by performing serial communication through these communication lines. It should be noted that all the above-described sensor detection signals need not be input commonly to the respective control units that constitute the ECU 2, but it is sufficient that only the sensor detection signals necessary for each control units to perform their control operations are input thereto.

In addition, this ECU 2 incorporates a self-diagnosis program for diagnosing failures of various portions of the subject of controlling, and automatically diagnoses the operating conditions of the microcomputer, the sensors 5, and the like at appropriate cycles. When a failure is recognized by this diagnosis, the ECU 2 generates a diagnosis code corresponding to the failure content, and stores this into a predetermined address of a back-up RAM of the ECU 2. In addition, the ECU 2 performs a warning process, such as lighting or blinking an MIL lamp, as necessary.

Next, the recording apparatus 1 according to the present embodiment will be described. This recording apparatus 1 is a detachable apparatus that records various data related to a vehicle (hereinafter referred to as “vehicle data”) and is mounted in the vehicle as needed. An example of the vehicle data that the recording apparatus 1 records includes control parameters of the ECU 2. Here, controlled variables computed in the ECU 2 are typically assumed as “control parameters,” but parameters used for computing these controlled variables (such as engine speed (rpm) and vehicle speed (km/h)) and learning values (control learning map) are also included. The recording apparatus 1 may also record, as the information accompanying the control parameters, sensor detection signals detected by the various sensors 5 and peripheral information of the vehicle. The peripheral information of the vehicle is the information related to the external peripheral environment of the vehicle, which include the atmospheric temperature outside the vehicle, the atmospheric pressure outside the vehicle, and the altitude and absolute location (latitude and longitude) in the vicinity of the vehicle.

A case in which the recording apparatus 1 is mounted in a vehicle includes a time of a periodic inspection, or a case in which the user finds some kind of failure and puts the vehicle in a service garage. In the former case, a test drive of the vehicle is performed by a serviceperson. In this case, the recording apparatus 1 acquires vehicle data during the test drive period at any necessary time, and records the acquire vehicle data as needed. In the latter case, the vehicle is temporarily returned to the user except for such a case in which a serviceperson can identify the failure easily. In this case, the recording apparatus 1 acquires vehicle data in a situation in which normal driving is performed by the user at any necessary time and records the acquired vehicle data as needed. When the test drive by the service person finishes or when the vehicle is put into the service garage again, the recording apparatus 1 is detached from the vehicle. Then, the vehicle data recorded in the recording apparatus 1 are used in order to identify whether a failure has been caused in the vehicle, or in order to identify the failure in the case where a failure has occurred.

Since the recording apparatus 1 is not an apparatus that is permanently mounted in a vehicle, no exclusive mounting space is prepared on the vehicle side, unlike the ECU 2. In the present embodiment, the recording apparatus 1 is mounted in a riding space for passengers (inside the vehicle), and is electrically connected to various cables provided on the vehicle side. Here, from the viewpoint of reducing the work load of the serviceperson, it is preferable that the recording apparatus 1 can be mounted easily and in a short time to the vehicle, while from the viewpoint of safety, it is preferable that the recording apparatus 1 can be mounted in a position where it does not obstruct the driver's driving operations. Moreover, from the viewpoint of avoiding electrical connection failures, it is preferable that the recording apparatus 1 can be fixed to the vehicle so that the recording apparatus 1 does not move easily while the vehicle is running. Taking these points into consideration, in the present embodiment, a hook-and-loop fastener (velcro strap) is bonded to the recording apparatus 1, and the recording apparatus 1 is mounted on a floor mat under a seat by means of the hook-and-loop fastener. This makes it possible to prevent the layout from obstructing driver's driving operations, to attain good attaching-detaching performance, and to fix the apparatus desirably. It should be noted that other than using the hook-and-loop fastener, the recording apparatus 1 may be fixed to a seat frame under a seat using a bolt, a screw, or the like as a means to fix the recording apparatus 1.

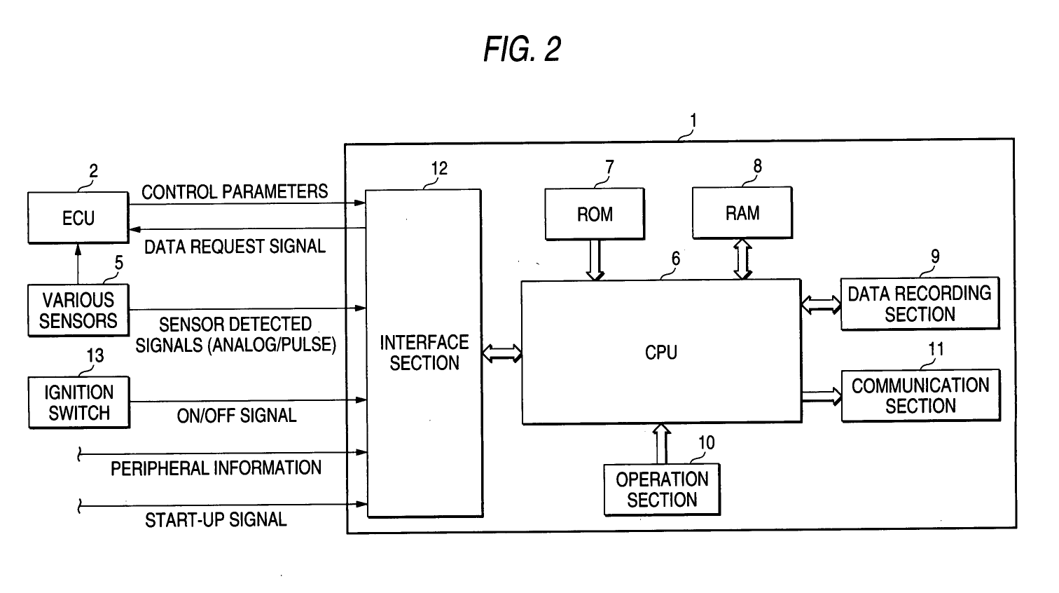

FIG. 2 is a block diagram showing a system configuration of the recording apparatus 1. The recording apparatus 1 is configured to mainly have a CPU 6, and a ROM 7, a RAM (random access memory) 8, a data recording section 9, an operation section 10, a communication section 11, and an interface section 12 are connected to a bus that is connected to the CPU 6. The CPU 6 performs the overall control of the entire recording apparatus 1, and by reading out a control program stored in the ROM 7, performs processes according to this program. The RAM 8 forms a work area that temporarily stores various process data to be executed by the CPU 6 and has a function as a buffer that temporarily records chronologically acquired vehicle data.

A series of vehicle data recorded in the RAM 8 are recorded by the CPU 6 in the data recording section 9 to which an external system can be accessed, on condition that the following condition is satisfied. In the present embodiment, taking into the versatility of the data recorded in the data recording section 9, a card-type non-volatile memory, for example, a flash memory-type memory card, that is detachable from the recording apparatus 1 is used as the data recording section 9. For this reason, the recording apparatus 1 is provided with a socket (or a drive) through which the CPU 6 can access the memory card, and when the recording apparatus 1 is mounted in the vehicle, the memory card is inserted into the socket in advance by a serviceperson. Thereby, the CPU 6 can record vehicle data into a memory card, which corresponds to the data recording section 9, or can read out the information recorded in the memory card. Various storage media such as a SmartMedia and an SD memory card can be used for this kind of memory card. These memory cards have a variety of storage capacities, ranging from 8 MB to 1 GB, and any memory card having a predetermined storage capacity can be used freely.

A mode file is recorded in the memory card that functions as the data recording section 9 in advance, and the CPU 6 sets an operating state the recording apparatus 1 by reading out the mode file from the data recording section 9. In this mode file, with anticipating a failure state that can occur in the vehicle in advance, a condition through which data of the vehicle effective for identifying the failure state will be obtained is appropriately set through experiments and simulations.

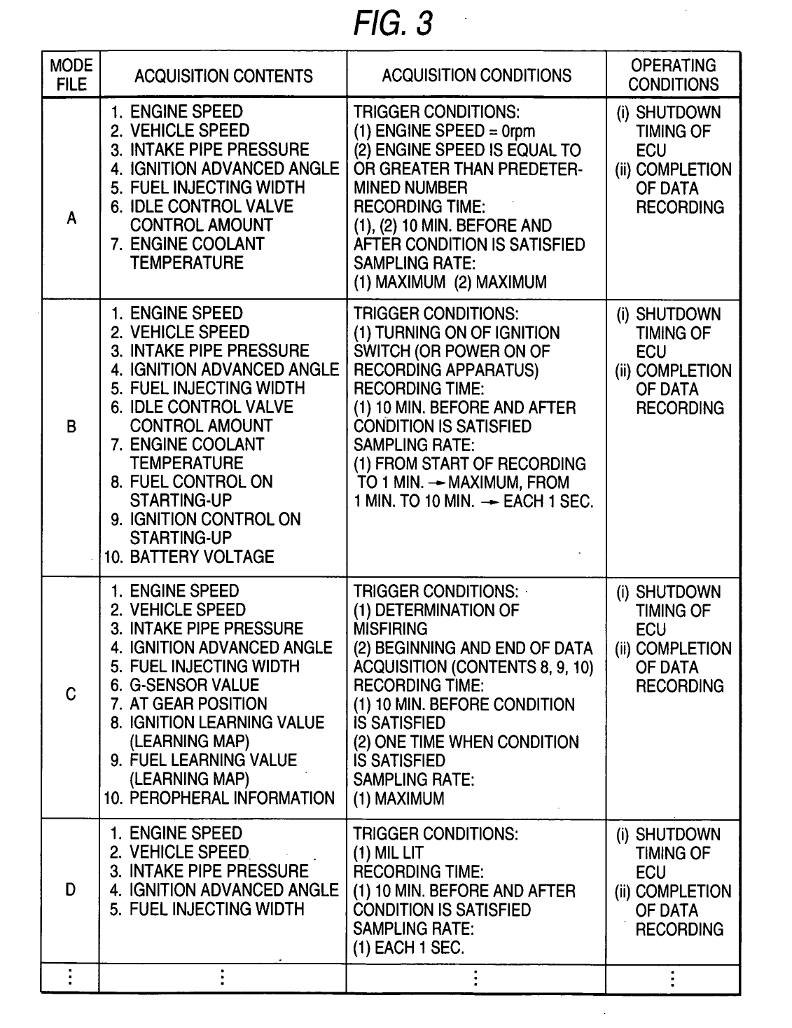

FIG. 3 is an explanatory view showing one example of the mode file. This mode file includes acquisition contents, acquisition conditions, and operation conditions. The acquisition contents are types of vehicle data that are the subject of recording. The acquisition conditions are conditions for acquiring and recording vehicle data according to the acquisition contents, and applicable conditions to these include sampling rate, trigger conditions, recording time, and so forth. The sampling rate is a cycle for acquiring vehicle data, and various cycles are set depending on acquisition contents. The trigger conditions are conditions when the acquired vehicle data are recorded from the RAM 8 into the data recording section 9. Examples of these trigger conditions include a predetermined point in the progression of vehicle data over time (for example, vehicle speed=0 km/h, or engine speed 0 rpm), ON of an ignition switch 13, a time point of generation of a failure code such as misfiring determination, a beginning and an end of data acquisition, and lighting of MIL lamp. The recording time is a length of vehicle data recorded from the RAM 8 to the data recording section 9, in terms of time, and an example is 10 minutes around the time when a trigger condition is satisfied. The operation conditions are conditions for shifting into an end operation (a later-described shutdown process) of the recording apparatus 1. In this recording apparatus 1, the operation termination of the ECU 2 is basically set as one of these operation conditions since the vehicle data must be recorded so as to be linked with the operation of the ECU 2 (operation condition (1) in the figure).

It should be noted that when vehicle data are recorded into the data recording section 9 according to the acquisition contents and the acquisition conditions at certain timing, it is anticipated that such an incident may arise that a situation that meets the acquisition contents and the acquisition conditions cannot occur in the operation cycle thereafter (completion of data recording). For example, as the mode file B shown in FIG. 3, in the case in which it is described as the acquisition conditions that vehicle data should be recorded for only 10 minutes from the ON of the ignition switch 13, a completion of data recording is brought about by recording the vehicle data for the 10 minutes into the data recording section 9. In such a case, even when the operation of the ECU 2 is continued, a circumstance in which vehicle data should be recorded does not arise; therefore, the necessity for the recording apparatus 1 to be operated is low. For this reason, a secondary operation condition, the condition being a completion of data recording, is also set in the mode file (operation condition (ii) in the figure).

In the example shown in the figure, the mode file A is a mode file in which rough idling is assumed as a failure state. According to this mode file A, the recording apparatus 1 acquires vehicle data such as engine speed, vehicle speed, intake pipe pressure, ignition timing advancing angle, fuel injecting width, idle control valve control amount, and engine coolant temperature with a maximum sampling rate (for example, 10 msec.). Also, during an acquisition period of vehicle data, with the engine speed becoming 0 rpm being a trigger, the vehicle data for 10 minutes around the timing at which the condition is satisfied are recorded into the data recording section 9. Alternatively, with the change amount of the engine speed becoming equal to or greater than a predetermined value being a trigger condition, the vehicle data for 10 minutes around the timing at which the condition is satisfied are recorded into the data recording section 9. Then, in principle, with the operation termination of the ECU 2 being a condition, the recording apparatus 1 finishes acquisition and recording of vehicle data and moves to a shutdown process (when data recording is completed, it moves to a shutdown process at the timing of this completion). On the other hand, the mode file B is a mode file in which an engine start failure is assumed as a failure state, and the mode file C is a mode file in which abnormal vibration such as surging is assumed as the failure state. In contrast, the mode file D is not a mode file in which a specific failure state is assumed but is such a mode file that supports a wide range of use in which minimum vehicle data are acquired in various failure states.

For the mode files, there are a plurality of files that respectively correspond to difference failure states. Therefore, when the recording apparatus 1 is mounted in a vehicle, it is necessary as a precondition that a mode file that corresponds to the failure situation of the vehicle in which the apparatus is to be mounted is selected appropriately and recorded in the memory card. The selecting of a mode file and recording thereof into a memory card is carried out by a serviceperson in advance referring to the explanation of the failure state by the user and to diagnosis codes stored in a back-up RAM of the ECU 2.

The operation section 10 comprises a remote control unit provided with operation switches, and this remote control unit can be operated by a driver. When an operation switch is operated by a driver, an operation signal is output from the operation section 10 to the CPU 6, and thereby the CPU 6 records the vehicle data recorded in the RAM 8 into the data recording section 9. In other words, the operation of this operation switch functions as a trigger condition at given timing by a driver. It should be noted that the operation section 10 may further comprise an input means, such as a keyboard or a mouse.

The communication section 11 notifies the user of completion of the recording when recording of vehicle data that satisfy the acquisition conditions is completed appropriately. In the present embodiment, the communication section 11 mainly comprises an LED and is controlled so as to be lit or blinked when the recording of the vehicle data described in the acquisition conditions is appropriately completed. Thereby, notification of the completion of recording of the vehicle data can be done to the user effectively. It should be noted that the communication section 11 may be structured by a CRT, a liquid crystal display, a loudspeaker, or the like, and various configurations may be employed that can notify the driver of the completion of recording.

The interface section 12 includes various interfaces for transferring vehicle side data. The recording apparatus 1 is connected to CAN or K-Line on the vehicle side through the interface section 12 so that it can perform two-way communication with the ECU 2 on the vehicle side. Thereby, the recording apparatus 1 can acquire control parameters from the ECU 2 side and recognize the status of the ECU 2, such as generation of a diagnosis code. In addition, output signals from various sensors provided in the vehicle are input to the interface section 12 directly or indirectly via the ECU 2, and further, a signal (ON signal /OFF signal) that interlinks with ON or OFF of the ignition switch 13 and moreover various signals (start-up signals) that become a trigger at the later-described power-on are input thereto. Furthermore, the recording apparatus 1 can perform two-way communication with a general-purpose computer (external PC), which is an external system provided externally, via the interface section 12.

The recording apparatus 1 is connected to a battery 15 (cf. FIG. 1) provided on the vehicle side, and operates by electric power supplied from the battery 15. Nevertheless, even when power supply is cut off to ensure a power source necessary for the recording apparatus 1 to operate, the recording apparatus 1 is provided with a sub-battery (not shown). This sub-battery comprises, for example, a capacitor or the like that stores a predetermined capacitance. The electric power stored in the sub-battery is supplied to a variety of circuits that constitute the recording apparatus 1 as needed when an electrical connection between the battery 15 and the recording apparatus 1 is cut off. Further, although not shown in FIG. 2, this recording apparatus 1 is provided with a clock function for defining present date and time and a timer function for detecting timing with a predetermined period.

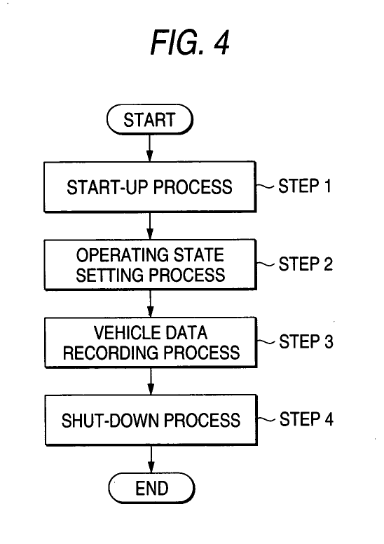

FIG. 4 is a flowchart showing a data recording procedure according to the present embodiment. The procedure of a recording process performed by the recording apparatus 1 proceeds in the order of a start-up process, an operating state setting process, a data recording process, and a shutdown process.

Start-Up Process (Step 1)

From the viewpoint of reducing power consumption of the battery 15, the power supply to the recording apparatus 1 is basically cut off when in an engine stop state. In view of this, the recording apparatus 1 performs power-on in synchronization with the starting of the vehicle, and thereafter performs starting-up of the system such as an operating system of a computer or the like. In this case, it is preferable that this recording apparatus 1 has started up the system of the recording apparatus 1 before the ON of the ignition switch 13 so that recording of vehicle data can be performed on the starting-up. For this reason, this recording apparatus 1 performs a start-up process using any of the following techniques 1 through 3, or a plurality of the following techniques in combination.

Technique 1 (Start-Up before the ON of the Ignition Switch 13)

When the ignition switch 13 is turned ON, a driver's getting-in action exists as its premise. In view of this, the recording apparatus 1 senses the driver's getting-in action and thereby performs a start-up process. The driver's getting-in action can be sensed by a signal from a smart key system, releasing of door lock, seating to a seat, contacting to a door, or vibration originating from opening/closing of a door. When the driver's getting-in action is sensed by a sensor or the like and a signal corresponding thereto is input as a start-up signal to the interface section 12, power is turned on for the recording apparatus 1 based on this signal.

Technique 2 (Start-Up in Synchronization with the ON Timing of the Ignition Switch 13)

When an ON signal output from the ignition switch 13 is input through the interface section 12, power is turned on for the recording apparatus 1 based on this ON signal. Alternatively, when a CAN communication signal has changed in the interface section 12 by the ON of the ignition switch 13, power is turned on for the recording apparatus 1 based on the change of the signal.

Technique 3 (Start-Up after the ON of the Ignition Switch 13)

A timer signal is input to the recording apparatus 1 at each predetermined time from a built-in timer (not shown), and based on this timer signal, power is turned on for the recording apparatus 1. When the system starts up with the power-on, the recording apparatus 1 outputs some data request signal to the vehicle side ECU 2. Normally, when the vehicle has started, the ECU 2 is operating; therefore, a signal corresponding to this data request signal is output from the ECU 2 side. Thus, the recording apparatus 1 judges whether or not the has started or not according to whether or not the signal from the ECU 2 has been received. If a predetermined signal is received from the ECU 2, the recording apparatus 1 continues the state in which apparatus has been started up. On the other hand, if the predetermined signal has not been received, the power supply is cut off. Then, power is turned on again in response to the input of the timer signal, and the same process is repeated.

It should be noted that, other than this, by providing a power switch for a remote controller corresponding to the operation section 10, the user himself/herself may perform the power-on of the recording apparatus 1 before turning on the ignition switch 13. In this case, power is turned on for the recording apparatus 1 based on an operation signal according to the user's operation of the power switch.

Operating State Setting Process (Step 2)

When power is turned on and the system starts up, an operating state setting is performed based on the mode file recorded in the data recording section 9. Specifically, the contents of the vehicle data to be acquired from the vehicle side are set based on the acquisition contents described in the mode file, and conditions concerning the acquisition and recording of vehicle data are set based on the acquisition conditions. Thereby, the recording apparatus 1 is set to be a state for acquiring and recording vehicle data according to the mode file.

Once the setting using the mode file is performed, the setting process in the subsequent operation cycles refers to an operation history. This operation history is information recorded into the data recording section 9 each time a shutdown process is performed, in which the operating state of recording apparatus 1 at the time of the shutdown is described. By referring to this operation history, the recording apparatus 1 is restored into the same operating state as that in the previous shutdown process. This allows the operating state of the recording apparatus 1 in the previous operation cycle and the operating state of the recording apparatus 1 in the present operation cycle to have continuity, which is effective in such cases where data recording is performed over a plurality of cycles. As will be described later, this operation history only records minimum contents necessary for restoring the recording apparatus into the same operating state as that at the time of the previous operation shutdown. Therefore, even when reading out this and restore the operating state, the time required therefor becomes shorter than that required for reading the mode file. As a result, the response characteristics of the recording apparatus 1 for the recording operation can be improved even in such a case where vehicle data are recorded immediately after the start-up of the recording apparatus 1.

Data Recording Process (Step 3)

When an operating state is set in the foregoing step 2, first, a data request signal is output to the ECU 2 so as to acquire the control parameters that has been set as the acquisition contents. The ECU 2 is executing a normal system control operation as the vehicle has started, and when it receives the data request signal, the ECU 2 outputs control parameters according to the acquisition contents to the recording apparatus 1 until its own operation stops, while executing this system control operation. Consequently, when receiving control parameters according to the data request signal, the recording apparatus 1 acquires the received control parameters at a predetermined sampling rate, and records the acquired control parameters into the RAM 8 chronologically.

In addition, when the acquisition contents contain other vehicle data than the control parameters for the ECU 2, for example, a sensor detection signal, peripheral information, and the like, the recording apparatus 1 also acquires these data through the interface section 12 and records these into the RAM 8 chronologically. It should be noted that in such a case in which, as with an engine speed, the data corresponding to the acquisition contents exist both in the control parameters (computed values) of the ECU 2 and in the sensor detection signals, the recording apparatus 1 may acquire the sensor detection signal along with the control parameter and record both data into the RAM 8. Further, peripheral information can be acquired as sensor detection signals from respective sensors by individually providing sensors for detecting the peripheral information together with the recording apparatus 1. Nevertheless, when sensors that can detect such information are provided on the vehicle side, (for example, a thermometer and a GPS), it is also possible to utilize output signals from these sensors.

Then, when a trigger condition is satisfied during the data acquisition, the vehicle data recorded in the RAM 8 is recorded into the data recording section 9 according to the acquisition conditions. For example, with the mode file A shown in FIG. 3, when the engine speed that is being acquired reaches 0 rpm, it is judged that a trigger condition is satisfied. In this case, the vehicle data for 5 minutes before the timing at which the trigger condition is satisfied are read out from the RAM 8 and recorded into the data recording section 9. Along with this, the vehicle data that are recorded into the RAM 8 for 5 minutes after the timing at which the trigger condition is satisfied are recorded into the data recording section 9.

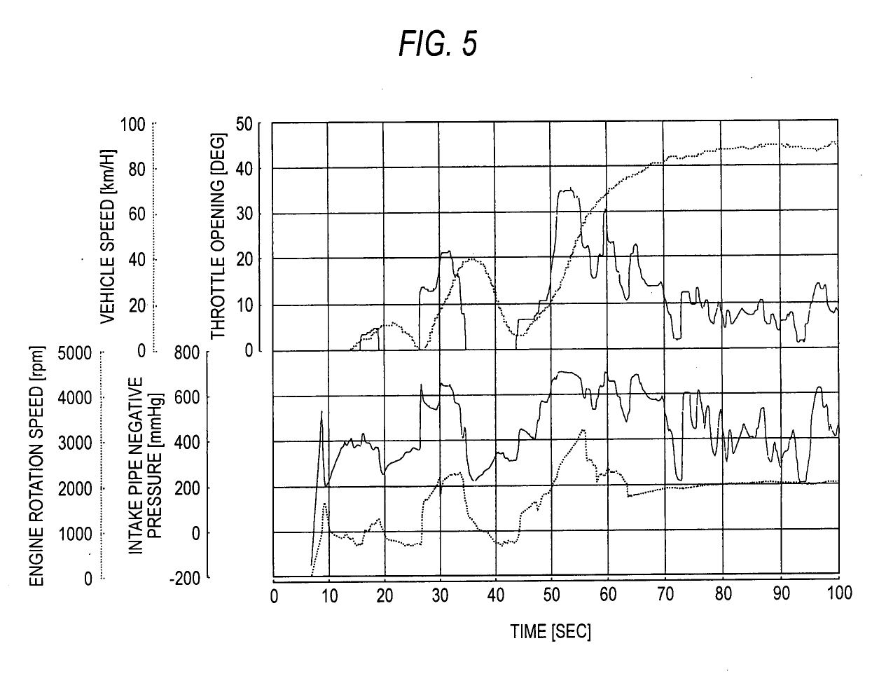

FIG. 5 is an explanatory view showing a chronological progression of vehicle data recorded in the data recording section 9. The figure illustrates vehicle speed (km/h), throttle opening degree (deg), engine speed (rpm), and intake pipe negative pressure (mmHg) as examples of the vehicle data. As shown in the figure, the vehicle data recorded in the data recording section 9 are associated with time information at the time of the acquisition and recorded. This time information used is an absolute time represented by date and time, or a relative time represented by an elapsed time from the start of the recording.

When the data recording is completed as the trigger condition is satisfied, a recording operation completion process is executed. In this completion process, the communication section 11 is controlled to light the LED and the acquisition of the vehicle data output from the ECU 2 is aborted. Then, the process moves to a later-described shutdown process. On the other hand, if the data recording has not been completed even when the trigger condition is satisfied, the data acquisition is continued until the trigger condition is satisfied again.

As shown in the operation conditions in the mode file, the data recording process ends together with the operation termination of the ECU 2 that is the subject of recording, except for the case in which the data recording is completed within one operation cycle. Generally, each of the control units that consititutes the ECU 2 has an individually-set operation termination timing. For example, the ABS-ECU ends its operation at the timing at which the ignition switch 13 is turned off, while the E/G-ECU 2a keeps operating for a certain time even after the ignition switch 13 is turned off and ends its operation thereafter. Thus, since the operation termination timing differs depending on the ECU 2 that is the subject of recording, it becomes necessary that the recording apparatus 1 itself monitors the operating state of the ECU 2 in order to end the data recording process at appropriate timing. In view of this, in the present embodiment, the operation termination of the ECU 2 is judged on the condition that vehicle data are not received from the ECU 2 although a data request signal has been output. However, because it is possible that the ECU 2 is temporarily in a non-continuity state, the recording apparatus 1 outputs the data request signal a predetermined number of times. Then, the recording apparatus has not received data after outputting the data request signal the predetermined number of times, the process moves to a shutdown process.

It should be noted that while such a series of data recording process is being performed, the recording apparatus 1 keeps monitoring the power supply line connected to a battery 15 of the vehicle. If the power supply is cut off, the process proceeds to a shutdown process in step 4. In this case, electric power is supplied from a sub-battery, which is not shown in the drawings, and thereby, the recording apparatus 1 operates.

Shutdown Process (Step 4)

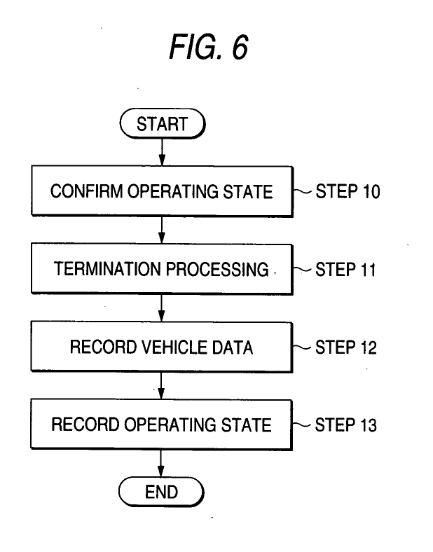

FIG. 6 is a flowchart showing a detailed procedure of a shutdown process. In the shutdown process, first, the present operating state of the recording apparatus 1 is confirmed (step 10). By this confirmation, the operating state of the recording apparatus 1 is classified into any one of the states among a vehicle data acquiring state, a vehicle data recording state, and a data recording completion. Here, the vehicle data accruing state is a state in which a trigger condition is not satisfied and data is being acquired from the vehicle side, and the vehicle data recording state is a state in which a trigger condition is satisfied and the vehicle data stored in the RAM 8 are being recorded into the data recording section 9.

In step 11, a termination process is performed. This process is a process for shifting to a state in which the power supply to the recording apparatus 1 can be safely cut off, since the operation of the recording apparatus 1 is being continued in the other states than the data recording completion. Accordingly, if the operating state is determined as the data recording completion in step 10, this step is skipped. In this step 11, if in the vehicle data acquiring state, the acquisition of vehicle data is aborted, while if in the vehicle data recording state, the acquisition of vehicle data is aborted and also the vehicle data that have not yet been recorded are recorded into the data recording section 9.

Then, in step 12, the vehicle data recorded in the RAM 8 are recorded into the data recording section 9. In this case, the recording apparatus 1 configures the vehicle data recorded in the data recording section 9 as one unit of data file in the present operation cycle. Thereby, the control parameters recorded in the data recording section 9 are configured as an individual data file each time of shutdown.

In step 13 subsequent to step 12, an operation history including parameter information and state information are recorded into the data recording section 9 based on the confirmed present operating state. The parameter information is minimum information necessary for restoring the operating state in the time of termination at the next starting up, and includes acquisition contents, acquisition addresses of the RAM 8, acquisition conditions, and the like. The state information is the confirmed operating state of the recording apparatus 1, and any one of the vehicle data acquiring state, the vehicle data recording state, and the data recording completion is recorded. When the operating state is recorded, the process exits this routine and accordingly the power supply is cut off.

Thus, according to the present embodiment, the vehicle data recorded in the RAM 8 are recorded in the data recording section 9 at time of shutdown of the recording apparatus. In the data recording section 9, basically, a data group indicating the chronological progression of the vehicle data having an acquisition condition is recorded according to a mode file. In addition to such a normal data recording, the vehicle data recorded in the RAM 8 are stored in the data recording section 9 at the time of shutdown, and thereby the vehicle data can be reliably recorded and preserved. As a consequence, it becomes possible to reduce such situations in which data recording fails, and therefore it becomes possible to improve reliability of the recording apparatus 1.

Moreover, according to this recording apparatus 1, electric power is supplied to the recording apparatus 1 by the sub-battery even in such a case where the power supply from the vehicle side is cut off. This makes it possible to perform a process (shutdown process) for safely shutting down the recording apparatus 1, and therefore, it becomes possible to prevent such a situation in which the vehicle data recording fails. Furthermore, even in such a case, by storing the vehicle data recorded in the RAM 8 in to the data recording section 9, the vehicle data can be reliably recorded and preserved. Still more, according to the present embodiment, because the vehicle data recorded at the time of shutdown are configured as one unit of data file, it is possible to identify necessary data easily in analysis, reducing the work load of serviceperson.

It should be noted that the data recording section 9 is not restricted to flash memory-type memory cards but various types of recording media, such as magnetic type and optical type. In such cases, the vehicle data recorded in the RAM 8 are recorded into a recording medium through a various type of drive controlled by the CPU 6. In other words, the data recording section 9 in the present invention need not be a constituting element of the recording apparatus 1, and it is sufficient that the recording apparatus 1 is at least capable of recording vehicle data into the data recording section 9. It should be noted that the data recording section 9 need not be detachable and may be provided integrally with the recording apparatus 1.

It will be understood to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

1. A data recording apparatus, operated by electric power supplied from a vehicle side, comprising:
a data recording section accessible by an external system and including a non-volatile memory for storing control parameters of a control unit mounted in a vehicle;
a random access memory for temporarily storing the control parameters chronologically acquired from the control unit; and
a data control section for recording, into the data recording section, a series of the control parameters within a predetermined period having an acquisition condition, among the chronological control parameters recorded in the random access memory, wherein the acquisition condition indicates a condition by which a vehicle data effective for identifying a failure state of the vehicle will be obtained,
wherein, at time of shutdown, the data control section records, into the data recording section, the chronological control parameters recorded in the random access memory irrespective of the acquisition condition.

2. The data recording apparatus according to claim 1, wherein the data control section records the chronological control parameters into the data recording section at time of shutdown performed when electric power supplied from the vehicle side to the data recording section is cut off.

3. The data recording apparatus according to claim 2, further comprising a sub-battery supplying electric power to the data recording apparatus at the time of the shutdown.

4. The data recording apparatus according to claim 1, wherein the data control section configures the control parameters recorded in the data recording section as an individual data file each time of shutdown.

5. A data recording method, for a data recording apparatus operated by electric power supplied from a vehicle side and for recording control parameters of a control unit mounted in a vehicle into a non-volatile memory in a data recording section accessible by an external system, comprising:
a first step of temporarily recording the control parameters chronologically acquired from the control unit into a random access memory;
a second step of recording, into the data recording section, a series of the control parameters during a predetermined period having an acquisition condition, among the chronological control parameters recorded in the random access memory, wherein the acquisition condition indicates a condition by which a vehicle data effective for identifying a failure state of the vehicle will be obtained; and
wherein in the second step, at time of shutdown, the chronological control parameters recorded in the random access memory are recorded in the data recording section irrespective of the acquisition condition.

6. The data recording method according to claim 5, wherein the second step comprises a step of recording the chronological control parameters into the data recording section at time of shutdown that is performed when electric power supplied from the vehicle side to the data recording section is cut off.

7. The data recording method according to claim 5, wherein the second step comprises a step of configuring the control parameters recorded in the data recording section as an individual data file at each time of shutdown.
